(19) United States
(12) Patent Application Publication
(10) Pub. No.: US 2004/0150128 A1
(43) Pub. Date: Aug. 5, 2004

(54) Method for producing a sound insulation component of variable thichness

(76) Inventors: Jean-Marie Houyoux, Mouzon (FR); Valerie Marcel, Brandeville (FR)

Correspondence Address: YOUNG & THOMPSON, 745 SOUTH 23RD STREET 2ND FLOOR, ARLINGTON, VA, 22202

(21) Appl. No.: 10/740,424

(22) Filed: Dec. 22, 2003

(30) Foreign Application Priority Data
Dec. 23, 2002 (FR) 02 16542

(51) Int. Cl. B29C 44/06

(52) U.S. Cl. 264/46.8

(57) ABSTRACT

Method for producing a sound insulation component of the spring-mass type. Additions of heavy material are locally deposited on a layer of heavy material having a substantially constant thickness producing. The additions of heavy material form an excess thickness on said layer of heavy material having a substantially constant thickness, in order to form therewith a sound insulation layer having a variable thickness. Then, a resilient layer is deposited. The resilient layer forms a sound absorber on the sound insulation layer, and connecting the sound absorption layer and the sound insulation layer together.

### BACKGROUND OF THE INVENTION

The invention relates to a method for producing a sound insulation component of the spring-mass type.

The object of the invention is in particular to improve the sound insulation of a vehicle whilst reducing the weight and cost of the sound insulation component. The sound insulation component is in particular intended to be positioned between the floor and the carpet of the vehicle or between the bulkhead and the dashboard.

There has already been provision for the adaptation of the features of the sound insulation component in different regions in order to adapt to the different sound stresses to which it is subjected in these different regions. In particular, U.S. Pat. No. 5,922,265 discloses the production of a sound insulation component by a discontinuous layer of heavy material being deposited inside a mould by means of an extrusion nozzle which can be moved in three directions, then by a sound absorption layer being linked to the discontinuous layer of heavy material when the mould is closed.

This solution is generally relatively troublesome to the extent that the operation consisting in depositing the layer of heavy material requires a corresponding length of time.

Furthermore, there have been proposals to produce the heavy material by injection. However, this solution necessitates relatively heavy investment and provides limited flexibility for varying the thickness of heavy material locally.

### SUMMARY OF THE INVENTION

In order to overcome this problem, the invention proposes that the following steps be carried out in succession:

a) a layer of heavy material having a substantially constant thickness is produced,

b) additions of heavy material are deposited locally and form an excess thickness on said layer of heavy material having a substantially constant thickness, in order to form therewith a sound insulation layer having a variable thickness,

c) a resilient layer is deposited and forms a sound absorber on the sound insulation layer, and the sound absorption layer and the sound insulation layer are connected together.

This solution allows the sound insulation features of the finished component to be readily optimised in accordance with the specific characteristics of each application. It further involves only a small amount of waste of sound insulation and sound absorption material. Finally, it necessitates modest investment and does not notably complicate the production method for the sound insulation component.

According to an advantageous feature of the invention, the layer of heavy material having a substantially constant thickness is thermoformed before step c).

In this manner, it is possible to adapt closely to the shape of the element which is intended to come into contact with the heavy material.

In order further to reduce the cost of the sound insulation component without reducing the performance thereof, the invention provides that a layer of foam of variable thickness is produced during step c).

In this manner, it will be possible to optimise the relationship between the thickness of the sound insulation layer and that of the sound absorption layer, given that the price relationship between the materials constituting them is generally of between five and ten.

To this end, the foam layer is preferably produced by foaming inside a mould.

In this manner, the foam layer is readily obtained in the desired shape without any loss of material, which is particularly advantageous in view of the price thereof.

### BRIEF DESCRIPTION OF THE DRAWINGS

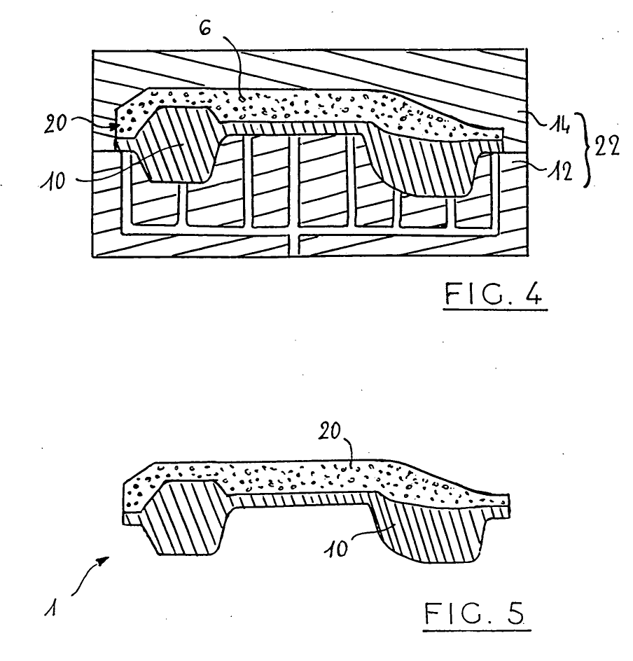

The invention will be appreciated more clearly from the following description which is given with reference to the appended drawings, in which the FIGS. 1 to 5 represent five successive steps of a method according to the invention.

### DETAILED DESCRIPTION OF THE PREFERRED EMBODIMENT

FIG. 1 illustrates a layer 2 of heavy material which is obtained in particular by calendering and which has a substantially constant thickness. This layer 2 of heavy material is heated here by a radiant plate 8 before being positioned on a thermoforming mould 12.

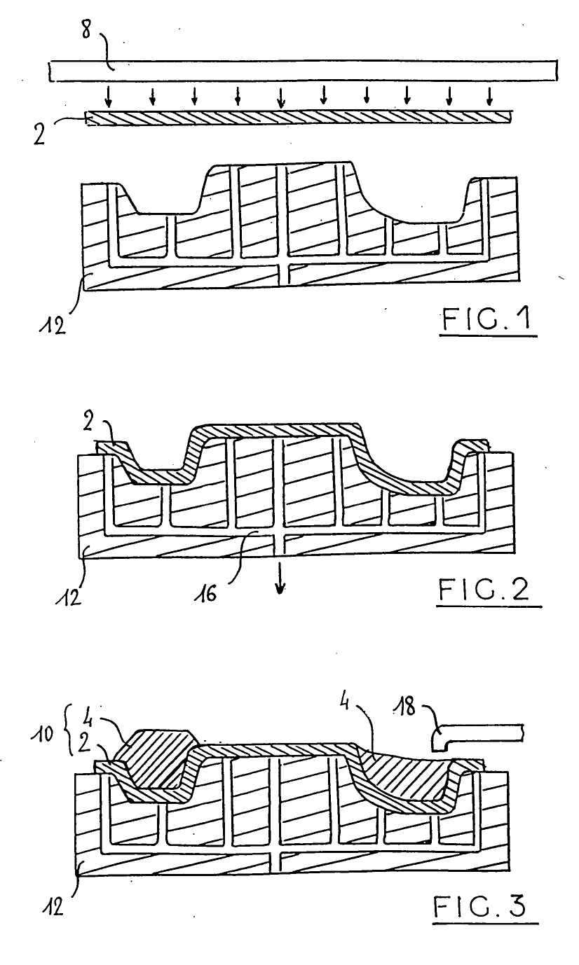

The layer 2 of heavy material is then evacuated under vacuum on the bottom die 12 by way of evacuation means 16 which are arranged in the bottom die 12, as illustrated in FIG. 2.

Next, additions 4 of heavy material are deposited on this layer 2 of heavy material, in given regions, forming locally an excess thickness by means of a lipped nozzle 18 of an extruder whose displacement is controlled by a robot. The additions 4 of heavy material then mix with the layer 2 of heavy material having a substantially constant thickness in order to form a sound insulation layer 10 of variable thickness.

As illustrated in FIG. 4, a die 14 is then brought into contact with the lower die 12 and foam 6 is introduced into the cavity 20 which extends between the sound insulation layer 10 and the die 14. This foam expands inside the cavity 20 until it fills it completely and forms a layer 6 which forms a sound absorber and which is connected to the sound insulation layer 10. In other words, the sound absorption layer 6 is produced by foaming inside the cavity 20 of the mould 22 which is formed by the lower die 12 and the die 14.

After removal from the mould, the finished component 1 comprises a sound insulation layer 10 and a sound absorption layer 6, both having variations in thickness.

The sound insulation layer 10 carries out the mass function (barrier) of the sound insulation component 1. The thickness thereof advantageously varies substantially between 0.1 and 5 millimetres. It is advantageously produced from thermoplastic material of the polyolefin type (ethylene vinyl acetate, polyethylene, ethylene propylenediene monomer) and includes waste products of the bitumen, chalk and/or barium sulphate type, allowing a high density to be obtained at little cost. The Young modulus thereof is preferably less than 1000 MPa and it has a density greater than or equal to 1500 Kg/m³.

The sound absorption layer 6 is arranged at the side of the source of the noise to be soundproofed. It carries out the spring function of the sound insulation component 1 by mechanically decoupling the heavy material from the element to which the sound insulation component is fixed. Furthermore, the layer 6 is porous in order to obtain good sound absorption. The sound absorption layer 6 is therefore porous-resilient. The thickness thereof advantageously varies substantially between 5 and 30 millimetres. It can be produced from plastics material, advantageously from polyurethane. The density thereof is preferably of between 15 Kg/m³ and 100 Kg/m³.

Of course, the invention is in no way limited to the construction which has been described merely by way of non-limiting example. In this manner, as an alternative, it would be possible to produce the resilient layer by selective depositing of felt in order to obtain finally a resilient layer which forms a resilient, uniformly dense absorber of felt.

It would also be possible to deposit the additions 4 of heavy material which form an excess thickness before the layer 2 of heavy material is moulded. In this manner, since the layer 2 is in a flat state when the additions are deposited thereon, the depositing by means of an extruder is easier.

We claim:

1. Method for producing a sound insulation component of the spring-mass type, comprising the following steps:
a) producing a layer of heavy material having a substantially constant thickness,
b) locally depositing additions of heavy material which form an excess thickness on said layer of heavy material having a substantially constant thickness, in order to form therewith a sound insulation layer having a variable thickness,
c) depositing a resilient layer which forms a sound absorber on the sound insulation layer, and connecting the sound absorption layer and the sound insulation layer together.

2. Method according to claim 1, wherein the layer of heavy material having a substantially constant thickness is thermorformed before step c).

3. Method according to claim 1 or according to claim 2, wherein a layer of foam of variable thickness is produced during step c).

4. Method according to claim 3, wherein the foam layer (6) is produced by foaming inside a mould.
